(19) United States
(12) Patent Application Publication
(10) Pub. No.: US 2010/0007559 A1
(43) Pub. Date: Jan. 14, 2010

(54) Shorted monopole antenna

(76) Inventors: Saou-Wen Su, Taipei City (TW); Jui-Hong Chou, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,302

(22) Filed: Aug. 27, 2008

(30) Foreign Application Priority Data
Jul. 11, 2008 (CN) 200810133548.8

(51) Int. Cl. H01Q 1/38

(52) U.S. Cl. 343/700 MS

(57) ABSTRACT

The present invention is related to a shorted monopole antenna. The antenna includes a ground plane, a main radiating element, a shorting element, a metal plate, and a coaxial cable. The ground plane includes a signal grounding point. The main radiating element is located above the ground plane and bent at least once, and includes a signal feeding point. One end of the shorting element is connected to one of the short edges of the ground plane, and the other end is connected to one edge portion of the main radiating element. The metal plate includes an inner conductor and an outer conductor, which are connected to the signal feeding point and the signal grounding point respectively. The antenna invented has good impedance bandwidth and radiation characteristics, can easily be installed inside the housing of an electronic device, and is well suitable for applications in wireless communications devices.

### BACKGROUND OF THE INVENTION

1. Field of the Invention

The present invention relates to a built-in antenna. The present invention in particular relates to a low profile shorted monopole antenna formed by a single metal sheet and capable of operating in the 2.4 GHz band.

2. Description of Related Art

With the development of wireless communication technology, various wireless products are widely marketed every year. Consequently related electronic circuit system and product design are focused for study and research. The mobile-unit antenna currently applied in WLAN system is a metal-plate structure or a PCB structure. The metal-plate antenna feeds RF signal by a mini-coaxial cable. On the other hand, the antenna of PCB type is almost a planar inverted-F antenna (PIFA), which is a planar antenna of inverted-F shape, and it is manufactured as a monopole antenna. The monopole antenna is constructed by a radiating unit and a grounding unit, which are separated units and do not connect with each other. An additional dielectric substrate is used for structure support for the radiating and grounding unit, and therefore the radiating rand grounding unit are printed on the dielectric substrate.

Generally speaking, the cost for manufacturing antenna of PCB type is higher than that for manufacturing the metal-plate antenna. A traditional planner monopole antenna is disclosed in Taiwan patent N.O. 00573382. The radiating unit and the grounding unit are respectively printed on two sides of a single dielectric substrate and the signals are fed in by a micro strip and a coaxial cable. According to other related patents, such as U.S. Pat. No. 6,600,448 and US 2007/0296636, the metal-plate antenna is made by molding and pressing the metal material. The two patents disclose a planar inverted-F antenna and the radiating unit and the grounding unit are formed on the same surface. Therefore, the necessary size of the antenna negatively affects the required space for the antenna, which is undesirable in this age of miniaturization.

### SUMMARY OF THE INVENTION

The primary object of the present invention is to provide a shorted monopole antenna, and in particular an antenna with a low profile. The shorted monopole antenna is formed from a metal sheet and it is applied to wireless band of 2.4 GHz. The antenna is suitable for being assembled inside a laptop computer, a wireless printer, and other wireless products that require or desire reduction in product size.

A single metal sheet is used for forming the antenna with a ground plane and a main radiating element by bending the metal piece according to the present invention. The main radiating element has at least one bending portion so as to reduce the height of the antenna and is disposed above the ground plane. Furthermore, a shorting element is used for connecting the main radiating element with the ground plane so that the main radiating element, the ground plane, and the shorting element can be manufactured integrally in one piece. In another embodiment, a metal plate connects to a long edge of the ground plane and performs as a grounding unit; therefore the antenna can be assembled flexibly. The shorted monopole antenna of the present invention can be applied to wireless band of 2.4 GHz (2400 to 2484 MHz) or for a band of 802.11b/g/n, and the antenna can be built in the wireless devices.

In order to achieve the above object, the present invention provides a shorted monopole antenna. The shorted monopole antenna comprises a ground plane, having a signal grounding point, wherein the ground plane defines a short edge and a long edge; a main radiating element, disposed above the ground plane, wherein the main radiating element has at least one bending portion and a signal feeding point; a shorting element, one side of the shorting element is connected with the short edge of the ground plane and another side of the shorting element is connected with the main radiating element; and a coaxial cable having an inner conductor and an outer conductor, the inner and the outer conductors connected electrically to the signal feeding point and the signal grounding point respectively. Thereby the antenna performs with good impedance bandwidth and radiation characteristics, and it is suitable for assembling inside the housing of the wireless units. It's proved that the antenna can operate in the frequency of wireless network of 2.4 GHz.

The present invention provides a shorted monopole antenna which is formed by bending a single metal sheet. The formed antenna system has a main radiating element and a ground plane that performs with good impedance bandwidth and radiation characteristics. Furthermore, the formed antenna system has a metal plate which is used for assembling with a predetermined unit and the metal plate will not affect the influence regarding the performance of the antenna system in the frequency band of 2.4 GHz. Therefore, the antenna of the present invention is flexibly assembled inside the wireless products and the metal plate can be designed to have mechanisms to enable assembling or attachment on to the desired electrical devices or wireless products.

In order to better understand the characteristics and technical contents of the present invention, a detailed description thereof will be made with reference to accompanying drawings. However, it should be understood that the drawings and the description are illustrative only and are not used to limit the scope of the present invention.

### BRIEF DESCRIPTION OF THE DRAWINGS

FIG. 1 shows the first embodiment of the shorted monopole antenna according to the present invention.

FIG. 1A shows the first embodiment of the shorted monopole antenna, before being formed, as a single metal sheet according to the present invention.

FIG. 2 shows the measured and simulated return loss of the first embodiment of the shorted monopole antenna according to the present invention.

FIG. 3 shows the measured radiation pattern of the first embodiment of the shorted monopole antenna operating at 2442 MHz according to the present invention.

FIG. 4 shows the gain and radiation efficiency of the first embodiment of the shorted monopole antenna according to the present invention.

FIG. 5 shows the simulated return loss of the first embodiment of the shorted monopole antenna with/without the metal plate according to the present invention.

FIG. 6 shows the second embodiment of the shorted monopole antenna according to the present invention.

FIG. 7 shows the angle between the metal plate and the ground plane of the third embodiment according to the present invention.

FIG. 8 shows the fourth embodiment of the shorted monopole antenna according to the present invention.

FIG. 9 shows the metal plate of the shorted monopole antenna according to the present invention.

### DETAILED DESCRIPTION OF PREFERRED EMBODIMENTS

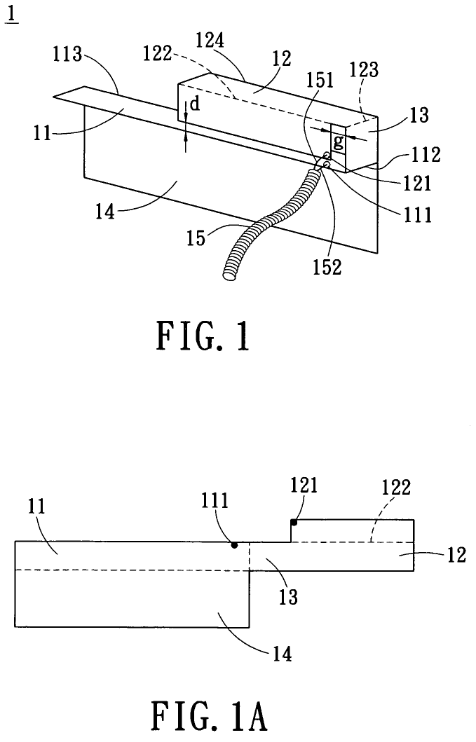

Please refer to FIGS. 1 and 1A, the present invention discloses a shorted monopole antenna 1. The first embodiment of the formed shorted monopole antenna 1 is shown in FIG. 1, and FIG. 1A shows the shorted monopole antenna 1 before being formed, as a single metal sheet. The shorted monopole antenna 1 includes a ground plane 11, a main radiating element 12, a shorting element 13, a metal plate 14, and a coaxial cable 15, and the above-mentioned elements (except the coaxial cable 15) are formed by bending a signal metal sheet. The ground plane 11 defines a short edge 112, a long edge 113, and has a signal grounding point 111. The main radiating element 12 is located above the ground plane 11 and it is bended by a bending portion 122. Furthermore, the main radiating element 12 has a signal feeding point 121. The main radiating element 12 defines a side 124 and an edge portion 123. One side of the shorting element 13 connects to the short edge 112 of the ground plane 11 and another side of the shorting element 13 connects to the edge portion 123 of the main radiating element 12. The metal plate 14 connects to the long edge 113 of the ground plane 11. The coaxial cable 15 has an inner conductor 151 and an outer conductor 152, wherein the inner and the outer conductors 151, 152 connects electrically to the signal feeding point 121 and the signal grounding point 111 respectively.

The ground plane 11, the main radiating element 12, the shorting element 13, and the metal plate 14 are made of conducting material. The metal sheet shown in FIG. 1A is used for forming the shorted monopole antenna 1 by bending methods such as a punching method. After forming process, a specific feeding gap d is selected and a distance g between the main radiating element 12 and the ground plane 11 is adjusted for balancing the inductive reactance and the capacitive reactance so that the well-defined VSWR (Voltage Standing Wave Ratio) of 1.5:1 is achieved.

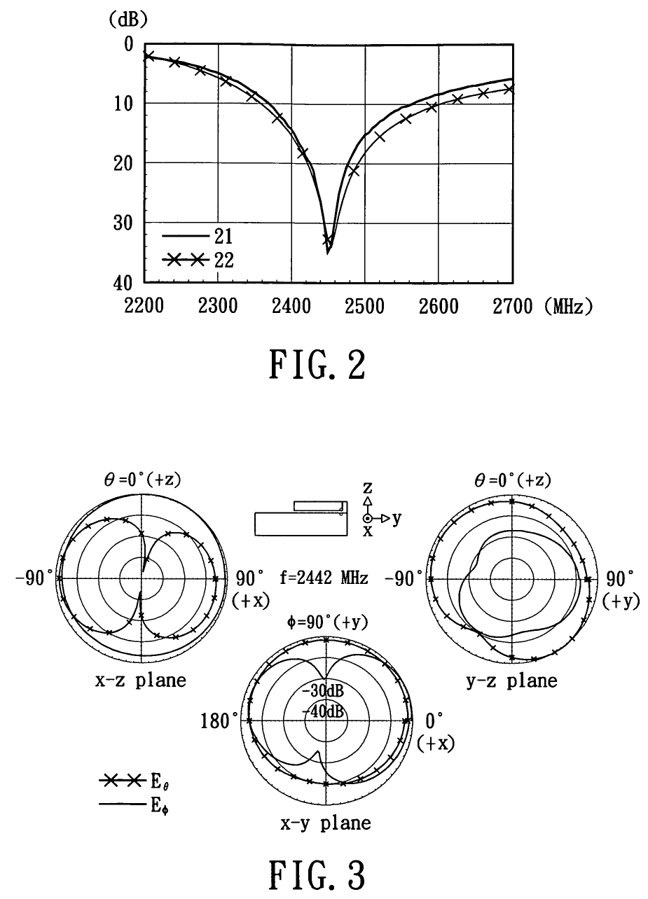

FIG. 2 shows the measured and simulated return loss of the shorted monopole antenna 1. The X-axis and the Y-axis represents the operating frequency (MHz) and the return loss (dB) respectively. In the first embodiment, the length and the width of the ground plane 11 are 40 mm and 5 mm respectively. The length of the main radiating element 12 is 23 mm, and the width and the height of the main radiating element 12 are both 5 mm (i.e. the length of the main radiating element 12 is shorter than that of the ground plane 11, and the width of the main radiating element 12 is not longer than that of the ground plane 11). The feeding gap d between the main radiating element 12 and the ground plane 11 is 1 mm (note that the feeding gap d can be a value smaller than 1.5 mm). The width and the length of the shorting element are both 5 mm and the distance g between the main radiating element 12 and the shorting element 13 is equal to 2 mm. Moreover, the length and the width of the metal plate 14 are 40 mm and 10 mm respectively. According to FIG. 2, in the definition of VSWR of 1.5:1 or return loss of 14 dB, the antenna 1 has good impedance matching in wireless frequency band of 2.4 GHz. In addition, the measured return-loss line 21 well matches with the simulated return-loss line 22.

The radiation pattern of the shorted monopole antenna 1 operating at 2442 MHz is shown in FIG. 3. According to the measured results, the radiation pattern on the X-Y plane is omni-directional.

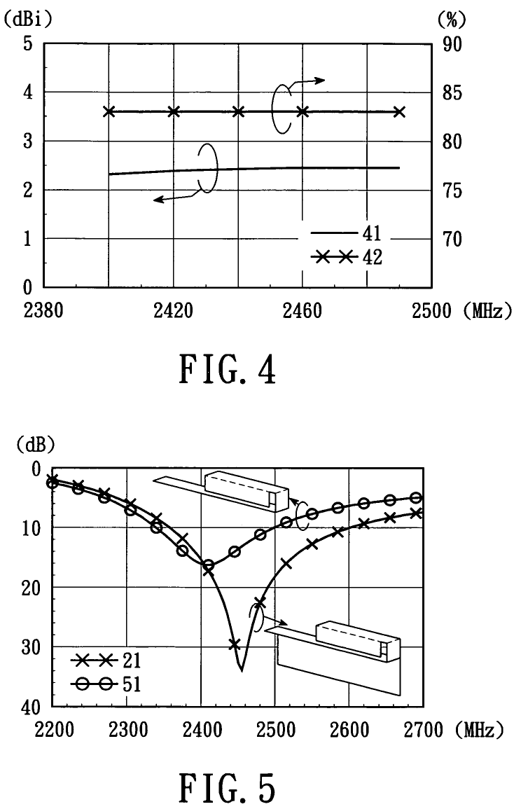

The measured antenna gain and radiation efficiency of the shorted monopole antenna 1 are shown in FIG. 4. The left-hand Y axis and the right-hand Y axis respectively represent the gain of antenna (dBi) and the radiation efficiency of antenna (%). Similar to FIG. 2, X axis represents the operating frequency (MHz). According to FIG. 4, the measured gain 41 shows that the value of the gain of antenna is 2.4 dBi and the measured data of efficiency 42 shows that the value of the radiation efficiency of antenna is 83%. Basically, the values of the operating data of the antenna in wireless frequency band of 2.4 GHz are qualified for wireless applications.

FIG. 5 shows the simulated return loss of the first embodiment with and without the metal plate 14. According to simulated line 51 of return loss; the impedance bandwidth of the shorted monopole antenna 1 without metal plate 14 is qualified for 2.4 GHz wireless applications.

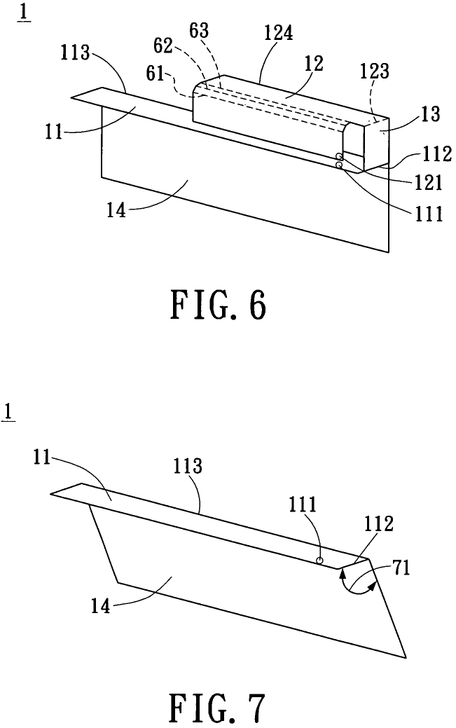

FIG. 6 shows the second embodiment of the present invention. The difference between the first and the second embodiments is that the main radiating element 12 has three bending portions, i.e. the first bending portion 61, the second bending portion 62, and the third bending portion 63 and these bending portions are parallel to each other. By the above-described structure, the height of the shorted monopole antenna 1 can be reduced so that it can be easily be assembled within a smaller space required.

FIG. 7 shows the third embodiment of the present invention. The difference between the third and another embodiment is that the angle 71 between the metal plate 14 and the ground plane 11 is not exactly 90 degrees. In this embodiment, the metal plate 14 “swings” away from the ground plane 11, wherein the angle 71 between the metal plate 14 and the ground plane 11 is larger than 90 degrees. Note that other elements such as main radiating element 12 of the antenna are not illustrated in FIG. 7, and the un-drawn elements are similar to those of the first and second embodiments. Thus, the metal plate 14 is used for being assembled within a housing of a wireless product, and the ground plane 11, the main radiating element 12, and the shorting element 13 can rotate to a specific angle in order to be applied to and fit in the space of the housing.

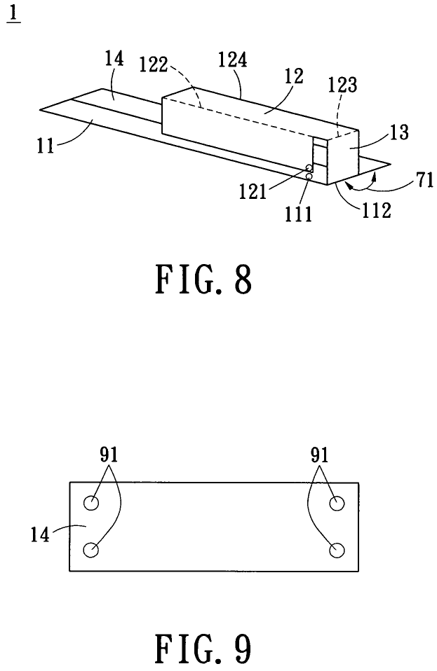

FIG. 8 shows the fourth embodiment of the shorted monopole antenna 1. The width of the metal plate 14 is equal to that of the ground plane 11. Moreover, the angle 71 between the metal plate 14 and the ground plane 11 approximates 180 degrees. Note that other elements such as main radiating element 12 of the antenna are the same as those of the first embodiment. Thus, the size of the shorted monopole antenna 1 can be further reduced because of the smaller metal plate 14 and the smaller ground plane 1. Similarly, the angle 71 can be adjusted for assembling the shorted monopole antenna 1 on a wireless device. In the fourth embodiment, the angle 71 is preferably between 45 to 180 degrees.

FIG. 9 shows the metal plate 14 of the shorted monopole antenna 1. The metal plate 14 has a plurality of holes 91 thereon for assembling the antenna on the base (i.e. one of the possible mechanism to enable assembling or attachment). For example, welding posts are assembled with the holes 91 to fix the antenna on a predetermined position.

The antenna of the present invention has a simplified structure and is easily to manufacture. Furthermore, the shorted monopole antenna 1 can be easily integratedly with wireless products.

Although the present invention has been described with reference to the foregoing preferred embodiment, it shall be understood that the present invention is not limited to the details thereof. Various equivalent variations and modifications may occur to those skilled in this art in view of the teachings of the present invention. Thus, all such variations and equivalent modifications are also embraced within the scope of the present invention as defined in the appended claims.

What is claimed is:

1. A shorted monopole antenna, comprising:
a ground plane, having a signal grounding point, wherein the ground plane defines a short edge and a long edge;
a main radiating element, disposed above the ground plane, wherein the main radiating element has at least one bending portion and a signal feeding point;
a shorting element, one side of the shorting element connected with the short edge of the ground plane and another side of the shorting element is connected with the main radiating element; and
a coaxial cable having an inner conductor and an outer conductor, the inner and the outer conductors connected electrically to the signal feeding point and the signal grounding point respectively.

2. The shorted monopole antenna according to claim 1, further comprising a metal plate connected with the long edge of the ground plane.

3. The shorted monopole antenna according to claim 2, wherein the main radiating element, the ground plane, the shorting element, and the metal plate are constructed by bending a single metal sheet.

4. The shorted monopole antenna according to claim 2, wherein the distance between the main radiating element and the ground plane is less than 1.5 mm.

5. The shorted monopole antenna according to claim 2, wherein the length of the main radiating element is shorter than the length of the ground plane.

6. The shorted monopole antenna according to claim 5, wherein the width of the main radiating element is shorter than or equal to the width of the ground plane.

7. The shorted monopole antenna according to claim 2, wherein the shorting element is located between the main radiating element and the ground plane.

8. The shorted monopole antenna according to claim 2, wherein the main radiating element has a plurality of parallel bending portions.

9. The shorted monopole antenna according to claim 2, wherein the angle between the metal plate and the ground plane is from 45 to 180 degrees.

10. The shorted monopole antenna according to claim 2, wherein the metal plate further comprises a plurality of holes thereon.
